(19) United States
(12) Patent Application Publication
(10) Pub. No.: US 2005/0154739 A1
(43) Pub. Date: Jul. 14, 2005

(54) Information transmission system and method

(75) Inventors: Takeshi Ikai, Tokyo (JP); Tadashi Tanikawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/035,080

(22) Filed: Jan. 14, 2005

(30) Foreign Application Priority Data
Jan. 14, 2004 (JP) 2004-006470

(51) Int. Cl. G06F 7/00

(52) U.S. Cl. 707/10; 718/102; 709/203

(57) ABSTRACT

An object is to easily achieve information transmission while maintaining the security. Provided are: a registered user storing device for storing identification information peculiar to a user being inputted from outside as a registered user information; an identification information reading-out device for reading out the identification information from an information storing device presented by a user, in which the identification information is stored; a user authentication device for authenticating whether or not the read-out identification information is stored in the registered user information; a transmission information receiving device receiving and storing the transmission information inputted from the user who is confirmed as a registered user based on the authentication result; an output request receiving device for receiving transmission information output request information which is inputted by another user when the identification information read out from the user by the identification information reading-out device is confirmed as that of the registered user based on the authentication result by the user authentication device; and a transmission information supplying device for outputting the stored transmission information to the user according to the output request information.

### BACKGROUND OF THE INVENTION

1. Field of the Invention

The present invention relates to a system and a method for information transmission and, specifically, to a system and a method for information transmission which can achieve communication in between users while maintaining the security without using portable information communication terminals.

2. Description of the Related Art

Conventionally, there are message boards which are mainly provided in train stations for achieving communications exchanged between each person while being out. In this communication, information to be communicated to the other party is written onto a blackboard or a whiteboard, and the other party reads it to obtain the necessary information.

However, the above-described message boards are installed in fixed areas so that information cannot be obtained without going to those places. Thus, in the case where it is not possible to go to those places, information to be communicated cannot be provided or obtained. Therefore, it is not suitable for a communication device used outdoors. Further, the medium for communication is limited to a written language and it is not possible to transmit information by voice or image, thereby causing inconvenience. Furthermore, the message boards are installed to be perused by public so that information to be transmitted cannot be kept in secret. Therefore, important matters cannot be transmitted.

Instead, due to spread of portable telephones, outdoor communications are often performed by using the portable telephones. By using the portable telephones as described, the portable telephones can be connected to each other so that it is possible to directly transmit information to other party at the time when it becomes necessary to change the meeting time and the like while being out. Thus, it is possible to have communication while maintaining the security. Also, when one party is out and the other party is at home, the same communication can be achieved. Further, in the same manner, by using a portable information communication terminal such as a PDA, it is possible to transmit information through an e-mail. Thus, it is also used as an important device as a communication tool used outdoors.

Further, if the both parties are in the conditions where they cannot use the portable telephones, it is not possible to have a communication by making a phone call. However, in addition to using the above-described e-mails or an answering machine, it is possible to have a communication using an electronic bulletin board on websites as disclosed in Japanese Patent Unexamined Publication No. 2001-338176. In Japanese Patent Unexamined Publication No. 2001-338176, by providing an electronic bulletin board for each member and limiting access to the bulletin board to each member, it enables to achieve communication while maintaining the security.

However, the communication using the portable telephones as described above can be performed only within a range where a radio wave from a communication base station reaches, so that communication cannot be achieved in places where the radio wave environment is deteriorated, e.g., underground complexes and mountainous regions. Also, it is necessary that the person has a portable telephone in the first place. As described above, examples of the places, which satisfy the both conditions of areas where a radio wave cannot be reached and the portable telephones are not carried, may be a skiing resort and a hot-spring resort. With a lot of people visiting those places, it is extremely inconvenient not to be able to communicate with a person at a distant place or a person of the same group visiting that place. This is also the same in the case of using the electronic bulletin board which is disclosed in Japanese Patent Unexamined Publication No. 2001-338176. That is, in order to make an access to the bulletin board, a user needs to use a terminal device such as one's own portable telephone.

### SUMMARY OF THE INVENTION

In order to improve the inconvenience caused in the conventional case as described above, it is an object of the present invention to provide a system which achieves communication between users by maintaining the security without using a portable information terminal.

The present invention has a configuration, comprising: a registered-user storing device for storing identification information peculiar to an individual user being inputted from outside as a registered user information; a transmission information receiving device for receiving and storing transmission information which is inputted by a user to be transmitted to another user; and also, an identification information reading-out device for reading out identification information from an information storing device presented by the user, in which the identification information is stored; an output request receiving device for receiving transmission information output request information which is inputted by a user along with the read-out identification information; and a transmission information supplying device for outputting the stored transmission information to another user when the identification information which is received along with the transmission information output request information is stored in the registered user information.

Likewise, the present invention employs a configuration, comprising: a registered user storing device for storing identification information peculiar to an individual user being inputted from outside as registered user information; an identification information reading-out device for reading out the identification information from the information storing device presented by the user, in which the identification information is stored; a user authentication device for authenticating whether or not the read-out identification information is stored in the registered user information; a transmission information receiving device for receiving and storing transmission information which is inputted by a user being authenticated as a registered user by the user authentication device to be transmitted to another user; an output request receiving device for receiving transmission information output request information which is inputted by another user who is authenticated as the registered user by the user authentication device; and a transmission information supplying device for outputting the stored transmission information to another user according to the transmission information output request information.

At this time, the identification information reading-out device may not read out the identification information peculiar to the user from the information storing device but may have a configuration for reading out the identification information on a human body, which is peculiar to each user, from a specific body part of the user oneself.

With such configuration, first, when the user provides the device such as the IC card in which the own identification information is stored or the body part such as a finger tip with a fingerprint to the reading-out unit of the system, the identification information peculiar to the user is read out by the system. Then, it is judged whether or not the user is the registered user based on the registered user information registered in advance. If it is an access from the registered user, the user is allowed to input the information to be transmitted to other users. The transmission information is received by the system in characters, audio, image or the like and the transmission information is stored thereby. Subsequently, in order to obtain the transmission information stored by another user, the identification information is inputted in the same manner as described above. When the user is authenticated as the registered user, it becomes possible to input the transmission information output request for the transmission information and the transmission information output request inputted by the user is received by the system. In response, the transmission information which has already been stored is read out and is outputted, so that the other user can check it through the system.

Thereby, input/output of the information transmitted between the users is performed only between the pre-registered users. Thus, it is possible to suppress other unrelated users who are not registered to obtain the information, thereby improving the security. In the present invention, especially, as the device for inputting the identification information peculiar to individuals, used is a device such as an IC card in which the identification information is stored or physical character on a body part such as a fingerprint. Thus, it can be always carried around with the user or it is unnecessary to memorize the information such as passwords, so that it improves convenience while the security is maintained. That is, since passwords are not used, it enables to effectively prevent impersonation by others. Also, it is unnecessary to always carry the portable telephones and the communicable potable information terminals as the communication tools, which have been conventionally used for maintaining the security. Therefore, it is possible to achieve communication between with other users even in areas where such instruments cannot be carried or in areas where it is unnecessary to carry them.

In addition to the above-described configuration, it may be in a configuration, comprising: a time information storing device for storing time information at which identification information is read out along with the identification information, when the identification information read out by the identification information reading-out device is authenticated by the user authentication device as that of a registered user; an authentication time request receiving device for receiving authentication time request information for requesting information which indicates authentication time state of other user, which is inputted by the another user being authenticated as a registered user by the user authentication device; and an authentication time output device for extracting user information, specifying the user and recognizable by the another user, which is stored in advance in the registered user information by the registered user storing device along with the stored user authentication time information based on the user identification information stored along with the authentication time information, and outputting it to the another user according to the received authentication time request information.

Thereby, in the case where the user makes an access to the installed terminal other than inputting the transmission information as described above, the time when the user made access is stored and the time information is outputted to the user requesting it. Therefore, it is possible to know the moving state of other users, which can be utilized in the later communication.

Further, in addition to the above-described configuration, it is desirable that the present invention employ a configuration in which: the registered-user storing device has a group registration function of discriminating identification information of each user into specific groups according to input from outside and storing them as the registered user information, a user authentication device has a group specifying function for specifying a group to which the identification information read out by the identification information reading-out device according to the registered user information belongs; the transmission information storing device has a function of storing the transmission information inputted from the user having identification information belonging to a specific group by relating it to the specific group based on the authentication result obtained by the user authentication device; and the transmission information supplying device has a function of outputting the transmission information stored by being related to the group to another user according to the transmission information output request information inputted form a user having identification information belonging to a specific group based on the authentication result obtained by the user authentication device.

Thereby, first, when the registered users form a specific group by those who have communication with, the user identification information is registered by being distinguished into a specific group unit. When the user inputs the identification information by presenting the device or the like, it is checked whether or not the user is user-registered and also checked whether or not the user belongs to a specific group. At this time, if the user belongs to a specific group, by inputting the transmission information, it is stored by being related to the group. Further, when there is an output request from another user belonging to the group, the transmission information stored by being related to the group is outputted to the user. Therefore, by forming a group with a plurality of users using the identification information in advance, it becomes possible to share the transmission information within the group. Thus, it enables to limit the users having communication thereby and the security can be more improved.

At this time, in addition to the above-described configuration, it may have a configuration, comprising: a time information storing device for storing time information at which identification information is read out along with the identification information, when the identification information read out by the identification information reading-out device is authenticated by the user authentication device as that of a registered user; an authentication time request receiving device for receiving authentication time request information for requesting information which indicates authentication time state of other user, which is inputted by the another user being authenticated as a registered user by the user authentication device; and an authentication time output device for extracting user information of other user for specifying the user and recognizable by the another user, which is stored in advance in the registered user information by the registered user storing device, along with the stored authentication time information of the other user belonging to a specific group to which the another user, who has inputted the authentication time request information belongs, based on the identification information of the other user stored along the authentication time information, and for outputting it to the another user according to the authentication time request information inputted by another user having identification information belonging to a specific group based on an authentication result obtained by the user authentication device. Therefore, as described above, it is possible to know the moving state of other users, which can be utilized in the later communication.

Further, in addition to the above-described configuration, it is desirable that the present invention employ a configuration in which the transmission information receiving device has a function of receiving inputted identification information for specifying other user as a target for outputting the transmission information from a user who inputs the transmission information along with the transmission information and of storing the transmission information relating to the specified identification information; and the transmission information supplying device has a function of outputting the transmission information related to the identification information to the another user when the identification information of the user who has inputted the output request information coincides with the specific identification information which is being related at the time of storing the transmission information. Thus, it is possible to transmit the information only to the specified user so that the security of the information supply system can be improved.

More specifically, the present invention employs a configuration comprising a plurality of installed terminals and an information storage server connected through a network, wherein the installed terminal comprises: an identification information reading-out device for reading out identification information from the information storing device presented by a user, in which the identification information peculiar to the user is stored; a user authentication inquiry device which inquires whether or not it is a pre-registered user by transmitting the read-out identification information to the information storage server and also receives an authentication result from the information storage server; the transmission information receiving device which receives transmission information for another user, which is inputted by a user being authenticated as a registered user based on an authentication result and transmits the transmission information to the information storage server; the output request transmitting device which receives transmission information output request information, which is inputted by another user being authenticated as a registered user based on an authentication result and transmits the transmission information output request information to the information storage server; the transmission information supplying device which outputs to another user the transmission information outputted from the information storage server according to the transmission information output request information; and the information storage server comprises: a registered user storing device for storing the identification information peculiar to the user as the registered user information based on input from outside; a user authentication device for authenticating whether or not the identification information transmitted from the installed terminals is user-registered based on the registered user information and for informing an authentication result to the installed terminals; a transmission information storing device for receiving and storing transmission information inputted by a registered user, which is transmitted from the installed terminals; and a transmission information output device for outputting, to the installed terminals, the stored transmission information for providing it to the registered user according to the transmission information output request information inputted by the registered user, which is transmitted from the installed terminals.

At this time, it may have a configuration in which the installed terminal comprises: a time information transmitting device for transmitting, to the information storage server, by relating, time information at which identification information of a user being authenticated as a registered user based on an authentication result obtained from the user authenticating device of the information storage server is read out by the identification information reading-out device, installing area information of the installed terminals, which is stored in advance in the installed terminals, and identification information of the user; an authentication time request transmitting device which receives authentication time request information for requesting information indicating an authentication time state of other users, which is inputted from another user being authenticated as a registered user based on an authentication result from the user authenticating device of the information storage server and transmits the authentication time request information to the information storage server; and an authentication time information supplying device for outputting to the user the information which is outputted from the information storage server according to the authentication time request information, and the information storage server comprises: a time information storing device for storing the time information transmitted by the time information transmitting device of the installed terminals, the installed area information, and the identification information by relating them; and an authentication time output device for extracting the user information for specifying the user and recognizable by another user, which is stored in advance in the registered user information by the registered user storing device based on the user identification information stored along the authentication time information and for outputting it to the installed terminal so as to supply it to the another user along with the stored authentication time information and the installed area information of the installed terminals according to the authentication time request information inputted by the registered user, which is transmitted from the installed terminals.

Further, it may have a configuration wherein: the information storage server comprises a plurality of identification information reading-out apparatus connected through the network; the identification information reading-out apparatus comprises: an identification information reading-out device for reading out the identification information from an information storing device in which identification information provided by a user, which is peculiar to the user is stored; and a time information transmitting device which transmits to the information storage server the time information at which the identification information is read out by the identification information reading-out device, installed area information of the apparatus stored in advance in the identification information reading-out device, and identification information of the user by relating them; and the installed terminals comprises: an authentication time request transmitting device which receives authentication time request information for requesting information indicating an authentication time state of other user, which is inputted from another user being authenticated as a registered user based on the authentication result obtained from the user authentication device of the information storage server, and transmits the authentication time request information to the information storage server; and an authentication time information supplying device for outputting to the user the information outputted from the information storage server according to the authentication time request information; and the information storage server comprises: a time information storing device for storing the time information, the installed area information, and the identification information transmitted from the identification information reading-out device by relating them; and an authentication time output device for extracting the user information for specifying the user and recognizable by another user, which is stored in advance in the registered user information by the registered user storing device based on the user identification information stored along the authentication time information and for outputting it to the installed terminal so as to supply it to the another user along with the stored authentication time information and the installed area information of the installed terminals according to the authentication time request information inputted by the registered user, which is transmitted from the installed terminals.

With such configuration, especially, the moving state of other users can be grasped more precisely as in the same manner as described above by corresponding to a plurality of installed terminals and installed areas of the identification information reading-out device. Thus, it can be better utilized for the later communication between the users.

Further, the present invention is a terminal installed in a prescribed area, which receives transmission information from the user and outputs the transmission information to other users. The terminal may have a configuration, comprising: an identification information reading-out device for reading out the identification information from an information storing device, in which the identification information peculiar to the user presented by the user is stored; a user authentication inquiry device which inquires whether or not the read-out identification information is that of the registered user by transmitting it to the information storage server being connected through a network, and receives an authentication result from the information storage server; a transmission information receiving device which receives the transmission information for another user inputted by the user who is authenticated as being the registered user based on the authentication result, and transmits the transmission information for storing it to the information storage server; an output request transmitting device which receives transmission information output request information inputted by another user being authenticated as the registered user based on the authentication result, and transmits it to the information storage server; and transmission information supplying device which receives the transmission information outputted from the information storage server in response to the transmission information output request information through the network, and outputs it to the user.

Further, the present invention is an information storage server being connected to installed terminals through a network for supervising transmission of transmission information from a user to other users, which is inputted from the installed terminals, wherein the information storage server comprises: a registered user storing device for storing identification information peculiar to an individual user as registered user information according to input from outside; a user authentication device which authenticates whether or not the identification information read out by an identification information reading-out, in which the identification information presented by the user is stored, is user-registered based on the registered user information, and also informs an authentication result to the installed terminals; a transmission information storing device for receiving and storing transmission information for another user from the installed terminals, which is inputted by a user being authenticated as a registered user based on the authentication result; and a transmission information output device which, upon receiving, from the installed terminal, transmission information output request information inputted to the installed terminal by another user who is authenticated as a registered user by the authentication result, outputs the stored transmission information to the installed terminal through the network for providing it to the registered user through the installed terminal according to the transmission information output request information.

In the above-described configuration, the identification information reading-out device provided to the installed terminal may have a configuration in which the identification information peculiar to the user indicated on a body of the user is read out from a specific body part of the user oneself.

Also, the present invention provides an information transmission method, comprising: an identification information reading-out step in which an identification information reading-out device reads out identification information from an information storing device in which the identification information provided by a user being peculiar to the user is stored; a user authentication step in which a user authentication device authenticates whether or not the identification information read out in the identification information reading-out step is stored in the registered user storing device in which identification information inputted from outside is stored in advance as registered user information; and a transmission information receiving step in which transmission information receiving device receives transmission information inputted for another user from a user who is authenticated as a registered user based on an authentication result obtained in the user authentication step and stores it to the transmission information storing device, and in addition, the method comprising: at least after completing the transmission information receiving step once, an output request receiving step in which an output request device, when the identification information of another user read out in the identification information reading-out step is authenticated as that of a registered user based on an authentication result obtained by the user authentication step, receives transmission information output request information inputted by the user, subsequently to the identification information reading-out step and the user authentication step; and a transmission information supplying step in which a transmission information supplying device provides the user with the transmission information stored in the transmission information storing device according to the transmission information output request information received in the output request receiving step.

In the information transmission method, the identification information reading-out step may be a step in which an identification information reading-out device reads out identification information peculiar to a user, which is indicated on a body of the user, from a specific body part of the user oneself by the identification information reading-out device.

Further, the present invention also provides a program for achieving each of the above-described devices and functions of the above-described installed terminals, the information storage server, and the identification information reading-out apparatus.

With such configuration, it is also possible to obtain the same functions and effects as described above and the above-described object can be achieved.

The present invention is constituted and functions as described above. Therefore, it is possible to transmit the transmission information stored through the system only to the pre-registered users so that communication can be achieved while maintaining the security. Also, by using the device such as the IC card in which the identification information peculiar to the individual used for authenticating whether or not the user is the registered user is stored, or using a physical characteristic such as a fingerprint, it is unnecessary to always carry a portable telephone or a communicable portable information terminal. Thus, it is possible to have communication with other users even in places where such instruments cannot be carried or in places where it is unnecessary to carry them. Thereby, it is possible to provide an information transmission system in which the convenience is improved while the security is maintained.

### BRIEF DESCRIPTION OF THE DRAWINGS

FIG. 1 is a block diagram showing an outline of the configuration of the present invention;

FIG. 2 is a schematic view showing an example of external appearance of an installed terminal;

FIG. 3 is a functional block diagram showing the configuration of the installed terminal:

FIG. 4 is a functional block diagram showing the configuration of an information storage server;

FIG. 5 is a sequence chart showing the operation of the entire system;

FIG. 6 is a flowchart showing the operation of user registration processing performed in the system;

FIG. 7 is a flowchart showing the operation of registration and output processing of transmission information in the system;

FIG. 8 is a flowchart showing a modification example of the operation of registration processing of transmission information in the system;

FIG. 9 is a flowchart showing the operation of group selection processing in the registration and output processing of the transmission information in the system; and

FIG. 10 is a flowchart showing a modification example of the operation of the output processing of the transmission information in the system.

### DESCRIPTION OF THE PREFERRED EMBODIMENTS

The present invention is a system in which transmission information from a user is received and stored by installed terminals and the stored transmission information is outputted according to requests from other users. At this time, identification information peculiar to an individual user is stored in advance in the system, and the stored transmission information is outputted only when the identification information of a user who is requesting the transmission information stored by another user is authenticated as being registered. Especially, the present invention is distinctive in respect that communication can be achieved with others without possessing a communication terminal such as a portable telephone since input of the identification information by the user is achieved by presenting the IC card in which the identification information is inputted or a finger print which is peculiar to an individual human being. In the followings, specific configurations of the present invention will be described in each embodiment.

### First Embodiment

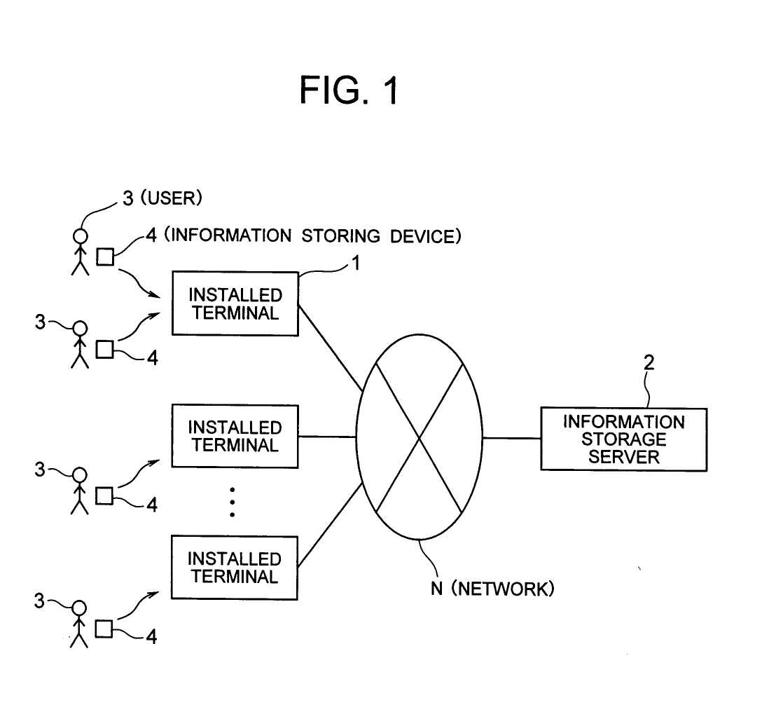

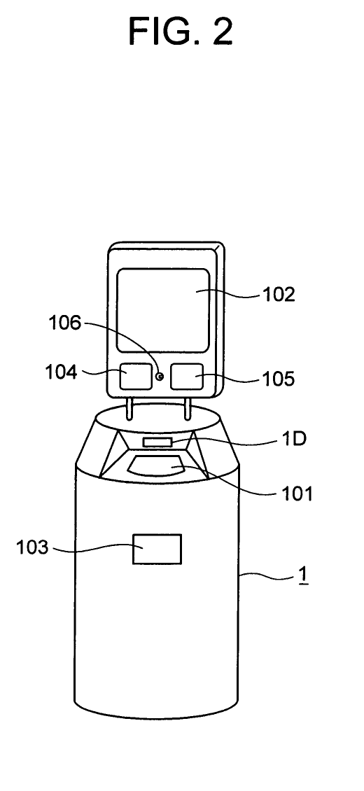

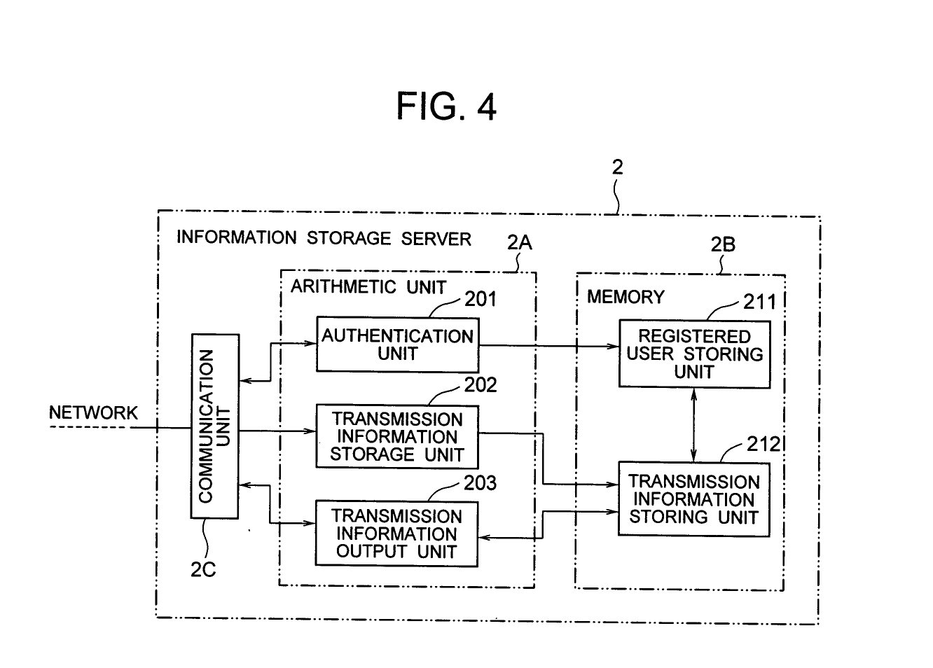

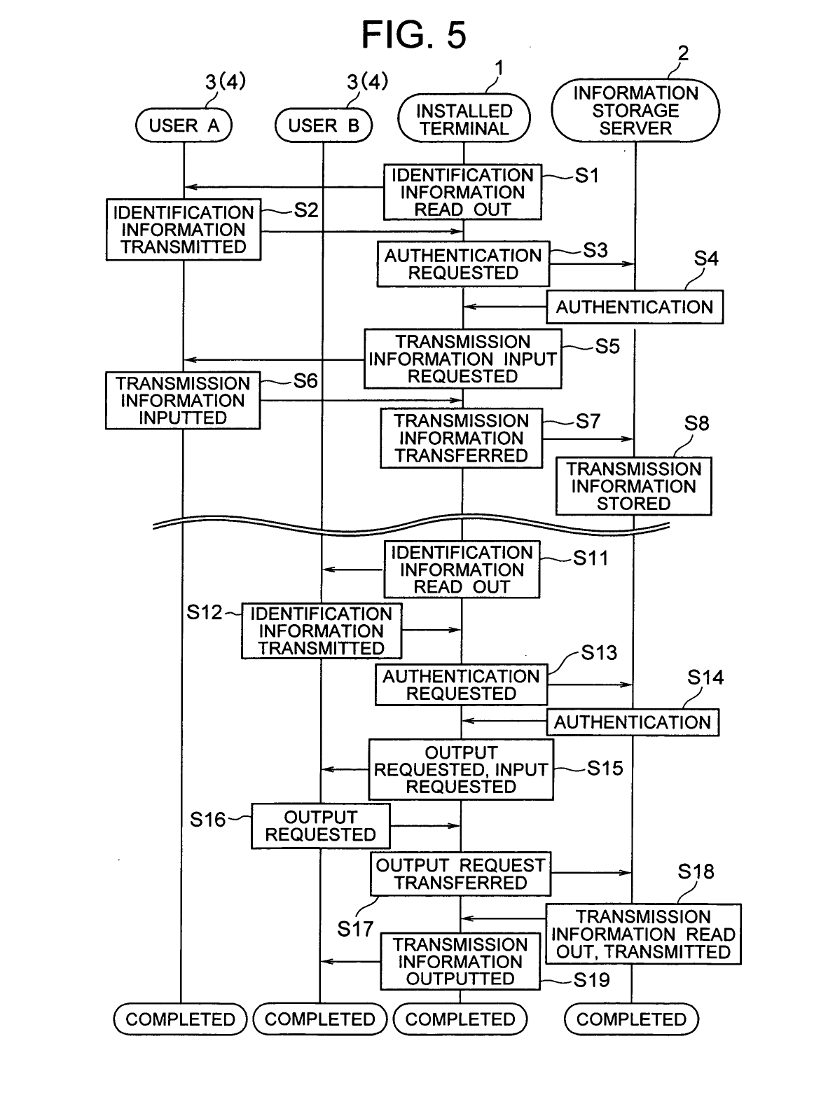

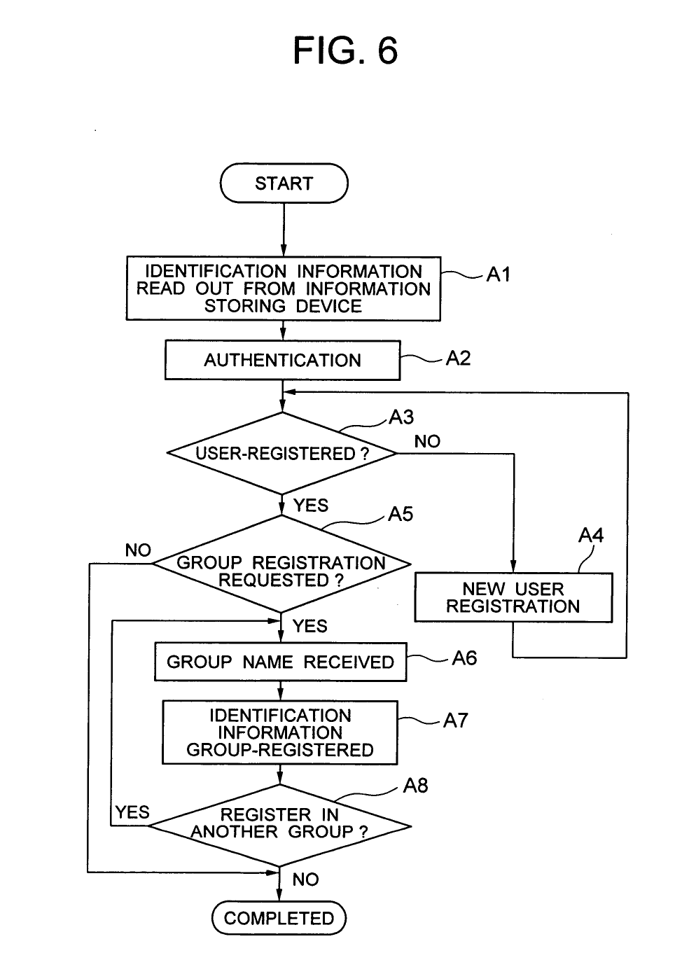

A first embodiment of the present invention will be described by referring to FIG. 1 to FIG. 10. FIG. 1 is a block diagram showing an outline of the overall configuration of an information transmission system as the present invention. FIG. 2 to FIG. 4 are illustrations showing external appearances and configurations of each device constituting the system. FIG. 5 is a sequence chart showing the operation of the system as a whole. FIG. 6 to FIG. 10 are flowcharts showing a specific operation in each processing by the system.

(Overall Configuration)

As shown in FIG. 1, the information transmission system according to the embodiment comprises a plurality of installed terminals 1 and an information storage server 2 connected through a network N. Description will be provided by referring to the case where the embodiment is applied to the information transmission system in a skiing resort, for example. The installed terminals 1 of the embodiment are installed in places such as at lift gates in the skiing resort, where information is often exchanged. These installed terminals 1 are connected to the information storage server 2 through a LAN cable and optical fibers. The information storage server 2 is placed in an information center and the like as the information sending office of the skiing resort to be supervised and operated. Accordingly, a user 3 who communicates with others using the system is the general public visiting the skiing resort. In the skiing resort, the portable telephones are out of the communicative range inmost of the cases, so that it is difficult to transmit information using the portable telephones carried by the users. Therefore, it is extremely effective to utilize the system according to the present invention.

An information storing device 4 is lent to the user 3 at the skiing resort to be carried. In the information storing device 4, the identification information for identifying the user is stored at the time when it is lent to the user 3. The installed terminal 1 comprises an identification information reading-out device for reading out the identification information from the information storing device 4 carried by the user 3 and input/output device for inputting/outputting the transmission information through characters, voice, image and the like for the user 3. Further, the information storage server 2 stores the user identification information stored in the information storing device 4 being lent to the user 3, and also stores the transmission information transmitted from the installed terminals 1.

Further, a plurality of the installed terminals 1 forms an information transmission network over the entire areas of the skiing resort through the combinations of the terminals, and one of the installed terminals 1 responds to the information storing device 4.

When the user 3 transmits information to other party in the skiing resort, by transferring the information in the information storing device 4 to the installed terminal 1, the installed terminal 1 is to be in the state waiting for an input of the information by the user 3. The user 3 outputs the information to be transmitted to the other party from the installed terminal 1. The information storing device 4 can produce the information to be transmitted to the other party using character data, audio data, image data and the like. The user 3 produces the information by selecting the data which is suitable for the information to be transmitted from the installed terminal 1 to the other party. The installed terminal 1 outputs the information inputted by the user 3 to the information server 2 through the network N. The information storage server 2, upon receiving the information of the user 3 from the installed terminal 1, stores the information.

When the user 3 of the other party transfers the information of the information storing device 4 being carried to the installed terminal 1 and the user 3 of the other party makes an access to the information storage server 2 by operating the installed terminal 1, the information storage server 2 analyzes the information from the installed terminal 1. If being authenticated, the information storage server 2 forms a communication channel between with the installed terminal 1. The information storage server 2, upon receiving the information from the installed terminal 1, searches for the transmission information corresponding to the information and outputs the corresponding communicative information to the installed terminal 1. The installed terminal 1, upon receiving the transmission information from the information storage server 2, presents the transmission information to the user 3 of the other party. The user 3 of the other party obtains the transmission information transmitted from the installed terminal 1 to the user oneself.

Authentication of the users making access to the installed terminal 1 is performed by using the identification information inputted by the users. Input of the identification information is performed through a small information storing device or biometrics. In the followings, each configuration will be described in detail.

The place for installing the system is not limited to the skiing resort but may be any places. However, it is desirable to be installed in places where it is difficult for the users to use the portable telephones and places where the information storing devices such as cards which authenticate individuals are also used, e.g., theme parks such as amusement parks, hot-spring resorts, swimming pools, etc.

(Users)

As described above, the user 3 using the system is the general public visiting the skiing resort. Description will be provided by referring to the case where communication is achieved in a group constituted of a plurality of users 3. Thus, each user is being distinguished by referred to as a user A, user B, user C, and the like in the description. The user A and the user B are the users of the same group visiting there together and the user C is the user of another group.

The information storing device 4 is lent to the users 3 at the time of entering the skiing resort or the time of purchasing lift tickets of the skiing resort. The information storing device 4 is formed to be in a coin-type or a card-type so as to be conveniently carried by the users 3, and a recording medium is built in. The identification information necessary for identifying the users 3 to which the devices are lent is stored in the built-in recording medium, and the information is stored in the information storage server 2. As the method for using the information storing device 4, first, the user 3 brings the information storing device 4 to be in contact or close to a reading device installed at a gate where the users pass through at the time of taking a lift, so that the identification information stored in the information storing device 4 can be read out. The above-described reading-out device at the gate, upon reading out the information stored in the information storing device 4, opens the gate for the user 3 to use the lift, if the information storing device 4 carried by the user 3 is valid. Thereby, the user 3 can use the lift.

The present invention utilizes the form of electronic tickets instead of the conventional lift tickets of paper medium. By presenting the information storing device 4 in this form at restaurants and other facilities in the skiing resort, the charges can be totaled in a computer by relating to the identification information stored in the information storing device 4. Thereby, payments can be settled later and it enables to use the facilities cashless. Such use method is well-known so that the detailed description will be omitted.

The information storing device 4 is constituted of “RFID (Radio Frequency Identification) card”, for example. The “RFID (Radio Frequency Identification)” is constituted of a reader/writer (antenna+controller) and an ID tag capable of storing information in an electronic circuit, and is capable of exchanging data by radio communication. That is, the reader/writer (reading-out apparatus) is installed at the gate of the lift, and by holding the “RFID card” against the reader/writer, the information making it possible to use the lift stored in the card can be read out by the reader/writer. In the “RFID card”, a CMOS chip constituted of an IC memory and a communication circuit, and a small antenna are built in. Although there is no power source being built in, it is possible to achieve communication by inducing power to the card through the radio at the time of reading and writing using the reader/writer. Therefore, it is possible to perform reading and writing of data without contact.

In the embodiment, the identification information peculiar to each user is stored in the above-described “RFID card (simply referred to as a “card” hereinafter)” functioning also as a lift ticket, which may be used by most of the visitors of the skiing resort. The identification information can be stored by automatically storing an identification number when the user 3 purchases the lift tickets or by inputting a special identification number to a vending machine for purchasing the tickets so as to record an arbitrary identification number in the card to be lent. For example, the identification information such as “aaaa” is stored in the card of the user A and the identification information such as “bbbb” is stored in the card of the user B. Also, in the same manner, the identification information such as “cccc” is stored in the card of the user C. The identification information is peculiar to the individual user. Thus, in the case where the users can register the arbitrary identification information, if the identification number which has been already used is inputted by the user, it is controlled by outputting the information to change the number at the time of issuing the tickets, etc. so that different users do not have the same identification numbers.

As described above, as the information storing device 4, the user 3 is to carry the card functioning also as the lift ticket in which the identification information peculiar to each individual is stored in the skiing resort. By holding the card being carried (information storing device 4) against the installed terminal 1, which will be described later, the own identification information can be inputted to the installed terminal 1. Subsequently, the user 3 operates the installed terminal 1 for performing user registration and a grouping of the users to which the information is transmitted before using the system. The operation associated with this will be described later.

(Installed Terminals)

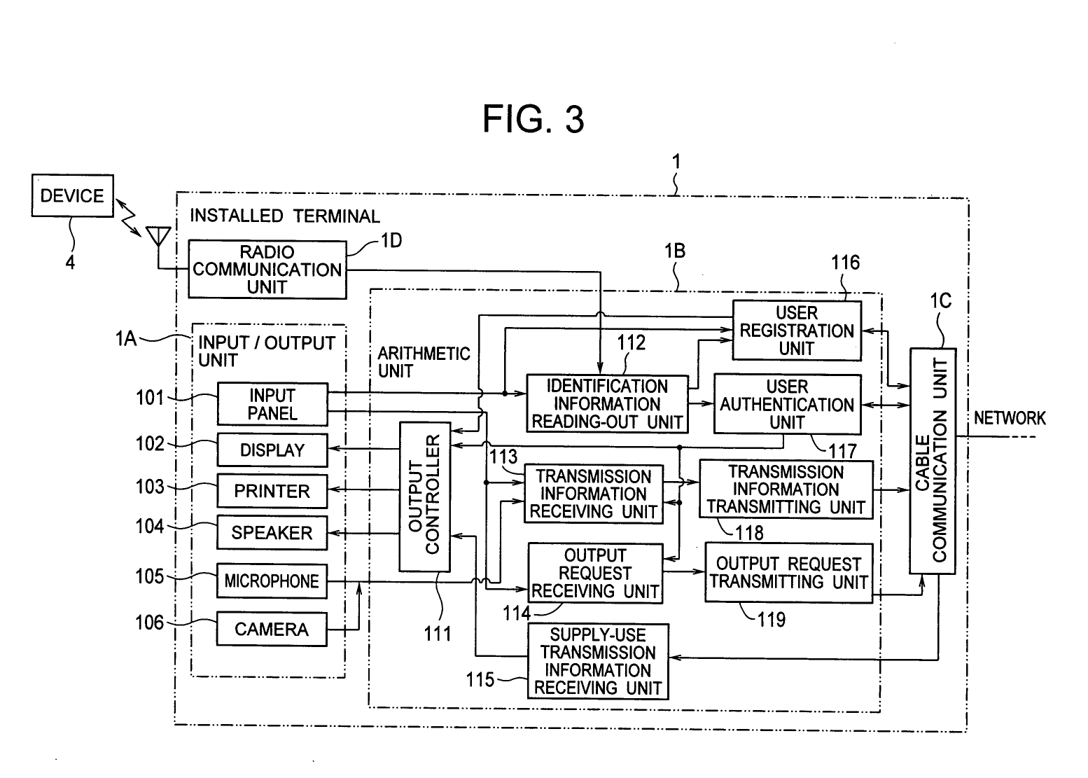

Next, the configuration of the installed terminal 1 will be described by referring to FIG. 2 and FIG. 3. The installed terminal 1 is provided in a plurality of areas of the skiing resort as described above especially at the gate of the lift, a lounge, and the like. FIG. 2 shows an example of the external appearance and FIG. 3 shows the configuration by a block diagram. The installed terminal 1, although it appears different, is constituted of an ordinal computer terminal, comprising an input/output unit 1A and an arithmetic unit 1B. Further, comprised are cable communication unit 1C to be able to be connected to the network N and a radio communication unit 1D for reading out data from the above-described RFID card without contact. These will be described in the followings.

First, the radio communication unit 1D is constituted of the reader/writer corresponding to the above-described RFID card and reads out the identification information peculiar to the individual user stored in the card. Then, the read-out identification information is transmitted to an identification information reading-out unit 112 inside the arithmetic unit 1B which will be described later.

Further, the cable communication unit 1C enables to exchange communication between with the information storage server 2 through a LAN cable, optical fiber cable, a telephone circuit, and the like. However, connection between with the information storage server 2 is not limited to the cable. The communication between with the information storage server 2 can be performed by providing a radio communication device which is different from the above-described reader/writer, and connecting it to the network N through a nearby radio communication base station.

In the installed terminal 1, various devices are provided as the input/output unit 1A. First, mounted are various input instruments such as a touch panel 101 for users to input the information, a microphone 105 for inputting audio information, and a camera 106 for recording moving pictures. Also, mounted are various output instruments such as a display 102 for displaying characters and images, a printer 103 for outputting the information displayed on the display to paper medium, and a speaker 104 for outputting the audio information.

Further, in a CPU as the arithmetic unit 1B, a processing unit which will be described later is built. First, built is an output controller 111 for controlling the information output state through each of the above-described each output instruments (the display 102, the printer 103, the speaker 104, and the like). Also, built is an identification information reading-out unit 112 for receiving the identification information read out from the card 4 by controlling the operation of the radio communication unit 1D as the above-described reader/writer. The identification information reading-out unit 112 and the radio communication unit 1D together operate as the identification information reading-out device.

In the arithmetic unit 1B, also built is a user authentication unit 117 (user authentication inquiry device) for inquiring whether or not it is a pre-registered user by transmitting the read-out identification information to the information storage server 2. The user authentication unit 117 also has a function of inquiring whether or not the user belongs to a specific group. The user authentication unit 117 receives the authentication result from the information storage server 2 based on the inquiring function, and outputs the information indicating that the user is the registered user and the information of the group to which the user belong to the output controller 111, a transmission information receiving unit 113, and an output request receiving unit 114. Then, the output controller 111 displays an indication on the display 102 for encouraging only the registered user to input the transmission information or the output request. Also, the transmission information receiving unit 113 or the like transmits the received transmission information and the output request information to the information storage server 2 along with the information on the user registration (including the group information).

Further, in the arithmetic unit 1B, built is a user registration unit 116 for user-registering the identification information to the information storage server 2 when new identification information is inputted. When receiving an input to perform user registration through the input panel 101 along with the input of the identification information from the user, the user registration unit 116 transmits the identification information to the information storage server 2 for requesting to perform user registration. Moreover, upon receiving the information for specifying the group to which the user belongs, which is inputted by the user through the input panel 101, the user registration unit 116 transmits the information to the information storage server 2 so as to make a request for group-registering the identification information.

Also, in the arithmetic unit 1B, built are the transmission information receiving unit 113 for receiving the transmission information inputted by a certain user (for example, the user A) through the above-described input instrument and a transmission information transmitting unit 118 for transmitting the received transmission information to the information storage server 2. These units operate as the transmission information receiving device. The transmission information receiving device operates when it receives the authentication result indicating that the user making an access is the registered user from the above-described user authentication unit 117. In other words, the information to be transmitted to other users cannot be stored unless the user is a registered user. Also, when the user belongs to a specific group, the transmission information is transmitted to the information storage server 2 along with the group information. Further, at the time when the user registers the transmission information, if the information which specifies the user for which the transmission information is outputted is inputted, i.e. the identification information of the user as the output target is inputted, the identification information as the output target user is also transmitted to the information storage server 2 along with the transmission information.

In the arithmetic unit 1B, also built are the output request receiving unit 114 for receiving the output request information which is the information for indicating a request from the other user (for example, the user B) for obtaining the already-stored transmission information through the input panel 101 and an output request transmitting unit 119 for transmitting the received output request information to the information storage server 2. These units operate as the output request transmitting device. The output request transmitting device, in the same manner as the above-described transmission information receiving device, operates only when the user (user B) who is making an access is authenticated as the registered user as a result of authentication. Also, when the user belongs to a specific group, the transmission information is transmitted to the information storage server 2 along with the group information.

Moreover, in the arithmetic unit 1B, built is a supply-use transmission information receiving unit 115 (transmission information supplying device) for receiving the transmission information which is outputted from the information storage server 2 according to the above-described output request from the user (user B), which operates to output the received transmission information from the display and the like to the user (user B) through the output controller 111. The specific operation will be described in more detail at the time of providing the description of the operation.

Each of the processing units (functions or device) built in the arithmetic unit 1B of the installed terminal 1 as described above can be achieved by installing programs for each of the processing units into the arithmetic unit 1B. These programs are supplied by being stored in portable media such as CD-ROMs or by being downloaded from other computers on the internet. Each processing unit built in the arithmetic unit of the information storage server 2 which will be described later can be also achieved by installing the programs for each processing into the arithmetic unit of the server 2.

(Information Storage Server)

As described above, the information storage server 2 is a server computer installed in an information center or the like of the skiing resort, comprising a CPU as an arithmetic unit 2A and a hard disk as a memory 2B. Further, it comprises a communication unit 2C and is connected to the above-described installed terminals 1 through a network N being built by a LAN cable and the like so as to be communicable.

In the arithmetic unit 2A, the following functions are built and, accordingly, the following information is stored in the memory 2B.

First, in the memory 2B, formed is a registered user storing unit 211 (device) for storing the identification information peculiar to the individual user as the registered user information based on the input from outside. Specifically, according to a command from the user registration unit 116 of the installed terminal 1 or according to a command directly inputted to the server 2 itself, the identification information of the user is stored as the registered user information. The processing unit for performing this processing is not illustrated in the arithmetic unit 2A.

In the registered user storing unit 211, the user identification information is not simply registered but it is distinguished into specific groups to be registered. In other words, according to the command information from the above-described user registration unit 116 of the above-described installed terminal 1 or the command information directly inputted to the server 2, the arithmetic unit 2A performs the group registration processing. For example, by referring to the case of the users A, B, C as described above, when there is an input indicating that the users A, B are in the same group, the respective identification information of the user A and the user B is related to the property of a group “a”. The identification information of the user C, which does not belong to any of the groups, is simply stored as a registered user.

Also, in the arithmetic unit 2A, built is an authentication unit 201 (user authentication device) for authenticating whether or not the identification information transmitted from the installed terminal 1 is user-registered based on the registered user information and for informing the authentication result to the installed terminal upon receiving an authentication request from the user authentication unit 117 of the installed terminal 1 as described above. The authentication unit 201, upon receiving the identification information of the user requested to be authenticated from the installed terminal 1, examines whether or not the user is a registered user by referring to the registered user information which is registered in the registered user storing unit 211. Also, along with this, it examines which group the user belongs to or not to (group specifying function). The result of the authentication, that is, the information on the status of user registration and the group to which the user belongs to is transmitted to the user authentication unit 117 of the installed terminal 1.

Further, in the arithmetic unit 2A, built is a transmission information storing unit 202 for receiving the transmission information inputted by the registered user, which is transmitted from the transmission information transmitting unit 118 of the installed terminal 1 and for storing it to a transmission information storing unit 212 formed in the memory 2B. When the user belongs to a specific group, the transmission information is transmitted along with the information on the group, so that the transmission information storing unit 202 stores the transmission information in the transmission information storing unit 212 by relating to the group. For example, the transmission information inputted by the user A is stored as the transmission information of the group “a”. When the transmission information includes the identification information for specifying the target user to which the information is outputted, it is stored by relating to the identification information.

Further, the arithmetic unit 2A comprises a transmission information output unit 203 for outputting the transmission information stored in the transmission information storing unit 212 to the supply-use transmission information receiving unit 115 of the installed terminal 1 for providing it to the registered user according to the transmission information output request information inputted by the registered user, which is transmitted from the output request transmitting unit 119 of the installed terminal 1. Especially, when the user who is requesting the output of the transmission information belongs to a specific group, the transmission information output unit 203 outputs the transmission information which is stored by being related to the group. For example, when there is a request for outputting the transmission information from the user B belonging to the group “a”, the transmission information from the user A related to the same group “a” is outputted. Also, it has a function of outputting the transmission information related to the identification information, when the identification information of the user requesting the output of the transmission information coincides with the identification information specifying the output target user, to which the stored transmission information is related.

(Outline of Operation)

Next, the operation of the entire system will be described by referring to the sequence chart shown in FIG. 5. In FIG. 5, the user A and the user B are separately illustrated. The user A is the one who registers the transmission information and the user B is the one who receives the transmission information. Here, it is assumed that the user A and the user B are the registered users.

First, for registering the transmission information, the user A holds the RFID card 4 in which the own identification information is stored against the reading-out section (section denoted by a reference numeral 1D in FIG. 2) of the installed terminal 1 to be almost in contact. Upon this, the installed terminal 1 performs radio communication with the card 4 for reading out the identification information (step S1) and, in response, the identification information is transmitted from the card 4 (step S2). Upon receiving the identification information, the installed terminal 1 transmits it to the information storage server 2 and requests to authenticate whether or not the user A is the registered user (step S3). In response, the information storage server 2 retrieves the registered user information for performing authentication and informs the authentication result to the installed terminal 1 (step S4). If the user A is the registered user, the installed terminal 1 displays an indication for encouraging an input of the transmission information (step S5) and receives the transmission information inputted thereby from the user A (step S6). Then, the installed terminal 1 transfers the transmission information to the information storage server 2 (step S7), and the information storage server 2 stores it (step S8).

Later, when the user B holds the own card 4 against the installed terminal 1 for receiving the transmission information from another user, authentication is performed to determine whether or not the user B is the registered user (step S11 to step S14) as in the same manner as the operation shown in the step S1 to step S4 described above. If the user B is the registered user, the installed terminal 1 displays an indication for encouraging an input of the output request (step S15) and receives the output request inputted thereby from the user B (step S16). Then, the installed terminal 1 transfers the output request information to the information storage server 2 (step S17). In response, the storage server 2 reads out the stored transmission information and transmits it to the installed terminal 1 (step S18). Upon receiving the transmission information, the installed terminal 1 outputs it through an output apparatus which is selected according to the data form of the transmission information for presenting it to the user B (step S19).

Thereby, it enables to exchange the information only between with the users A and B, who are the pre-registered users. Especially, in the embodiment, a card functioning as a lift ticket which is almost necessarily used in the skiing resort is used as the information storing device 4 for authenticating the user, so that it is highly provable that the users carry one. Therefore, it enables to achieve communication with the maintained security. In the skiing resort, portable telephones may not be carried around since the radio wave is out of reachable range or the portable telephone may be broken when the person carrying it falls down or the like. Accordingly, the embodiment exhibits a remarkable effect in such area.

(Operation of Each Processing)

Subsequently, among the above-described operations, details of the operations of each processing performed by the installed terminal 1 and the information storage server 2 will be described by referring to flowcharts of FIG. 6 to FIG. 10.

First, by referring to FIG. 6, described is the operation performed when the user A (it is the same for other users) performs the user registration to the system. When the user A holds the card 4 as the information storing device in which the identification information is stored against the reading-out section of the installed terminal 1, the identification information is read out by the identification information reading-out unit 112 from the card 4 through the radio communication unit 1D (step A1). When the user A selects the “user registration” from the input panel 101 for inputting command information for performing user registration to the installed terminal 1 right before or right after, the identification information reading-out unit 112 recognizes it and transmits the read-out identification information to the user registration unit 116. At this time, the user information which can specify the individual such as name, sex, etc. is also inputted from the input panel 101. Thereby, the identification information (including the user information such as the name) is transmitted from the user registration unit 116 to the information storage server 2, and an inquiry is made to check whether or not the user is the registered user (step A2). In response, the authentication unit 201 of the information storage server 2 examines whether or not the received identification information is registered as the registered user information in the registered user storing unit 211, which has been already registered. At this time, if it is not user-registered (NO in step A3), the information storage server 2 registers the identification information of the user A to the registered user storing unit 211 (step A4), and the user information such as the name is also registered by being related to the identification information. The process of the user registration processing is not limited to this, but the registration may be performed automatically by using the identification information which is given randomly at the time of issuing the lift ticket.

If the user is pre-registered (includes after registering the new user as described above) (YES in step A3), it is so informed to the user registration unit 116 of the installed terminal 1 that the user is registered, and the user registration unit 116 makes an inquiry to the user A whether or not to be registered in a group (step A5). In other words, it displays the inquiry information on the display through the output controller 111. In response, upon receiving the information for requesting the group registration inputted by the user A through the input panel 101 (YES in step A5), and receiving an input of the group name (step A6), the information is transmitted to the storage information server 2 and the identification information of the user A is registered by the server 2 by being related to the group (step A7). At this time, if there is no such a group being registered under the inputted name, it is denied joining the group. By inputting a new group name is inputted along with the information for requesting to form a new group, a new group is registered. In this example, the users A and B are to belong to the group “α”.

Then, the display 102 displays selections of joining or not joining still another group, and if the user A inputs the information to join another group (YES in step A8), the processing of the above-described step A6 and step A7 are repeated.

Thereby, the user A is user-registered and also belongs to a specific group “α”. As described above, it is the same for the user B. In the meantime, the user C only performs the user registration and does not belong to any of the groups.

The registration of the group may be performed by other methods. For example, after the user A inputs the information requesting the group registration and the group name through the input panel 101 of the installed terminal 1, the user A and the user B hold the information storing device 4 in order against the radio communication unit 1D within a specific range of time. Thereby, the identification information of each of the users A, B is transmitted to the information storage server 2 and the users A, B are automatically registered in the same group. These functions are provided to the installed terminal 1 and the information storage server 2.

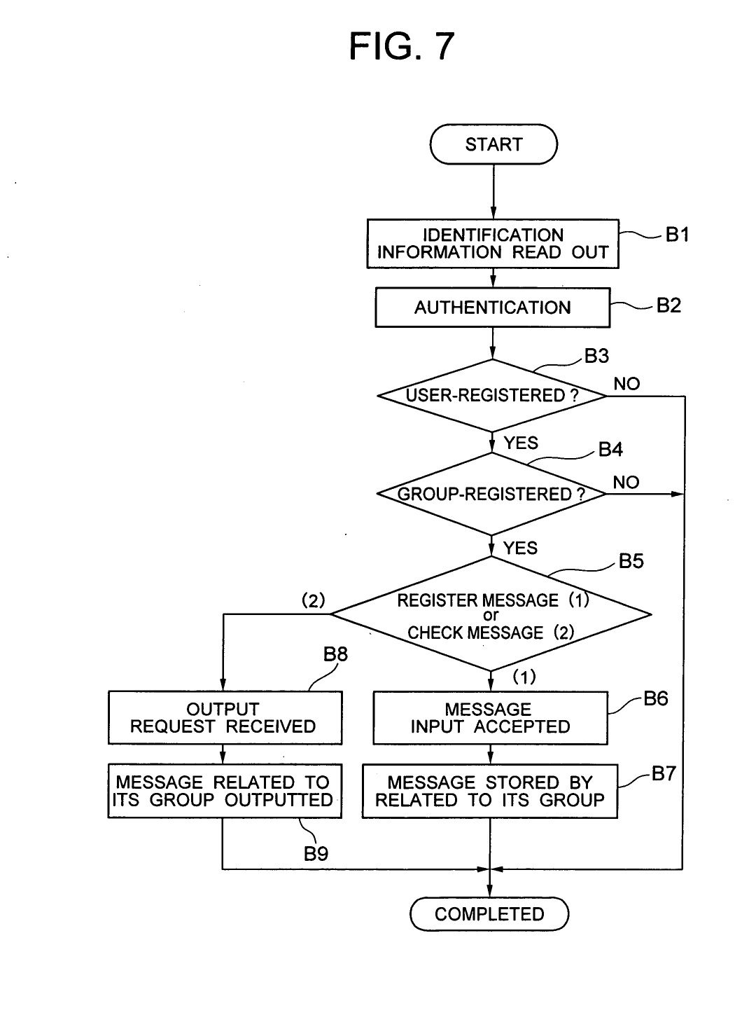

Next, described is the operation the system at the time when the user A registers the message as the transmission information by referring to the flowchart of FIG. 7.

First, by holding the card 4 against the installed terminal 1 in the same manner as described above, the identification information is read out from the card 4 by the identification information reading-out unit 112 of the installed terminal 1 through the radio communication unit 1D (step B1). At this time, there is no input of information for specifically requesting the user registration, the identification information is transmitted to the authentication unit 201 of the information storage server 2 through the user authentication unit 117 and is examined to check whether or not the user is registered in the registered user storing unit 211 (step B2). At this time, if the user is not user-registered (No in step B3), it is so informed to the user authentication unit 117 that the user is unregistered, and it is indicated on the display 102 through the output controller 111 that the massage cannot be registered. Thereby, the processing is completed. Meanwhile, if the user is user-registered (YES in step B3), it also checks whether or not the identification information is registered in a group (step B4). Then, in the same manner, if it is not registered in any of the groups (NO in step B4), it is indicated that the message cannot be registered, there completing the processing. In the meantime, if it is registered in the group, the group name is informed to the user authentication unit 117 and proceeds to the next processing. Although the example described herein is the case where only the users who have registered in a group can register the messages, it is not limited to this. The case where it is possible to register the messages as long as the one is the registered user will be described later.

Subsequently, upon receiving the authentication result indicating that the read-out identification information belongs to a group, the user authentication unit 117 shows an indication on the display 102 through the output controller 111 for asking the user whether to (1) register message or to (2) check message (step B5). In response, upon receiving an input from the user requesting to register the message through the input panel 101 (proceeds to (1) in step B5), shows an indication on the display 102 for encouraging to input a message and receives character information inputted from the input panel 101, audio information inputted from the microphone 105, movie information inputted from the camera 106 and the like by the transmission information receiving unit 113 (step B6). At this time, the group information to which the user belongs is informed as the authentication result from the user authentication unit 117 to the transmission information receiving unit 113 along with the identification information, so that it transmits the message information to the transmission information storing unit 202 of the information storage server 2 through the output request transmitting unit 119 by relating it to the identification information and the group information. Upon receiving it, the server 2 stores it in the transmission information storing unit 212 along with the identification information and the group information, or stores it by being related to the identification information and the group information in the registered user storing unit 211 (step B7). Thereby, the user A can register the message to be informed to the user belonging to the group.

In the meantime, in step B5, when the user selects the information to request to “check the message” through the input panel 101 (selects (2) in step 5B), the transmission information output request information is to be inputted by this selection and the output request (check request) of the message is received by the output request receiving unit 114 (step B8). At this time, the identification information and the group information of the authenticated user is informed from the user authentication unit 117, so that the output request information along with the information is transmitted to the transmission information output unit 203 of the information storage server 2 through the output request transmitting unit 119. Upon receiving it, the transmission information output unit 203 extracts the message related to the group from the transmission information storing unit 212 by referring to the group information of the user and transfers it to the supply-use transmission information receiving unit 115 of the installed terminal 1. Thereby, the supply-use transmission information receiving unit 115 outputs the message to the user through the output controller 111 according to the data form of the message (step B9). For example, if the message is character information, it is shown on the display 102 or printed out on a paper medium by the printer 103. If it is an audio data, it is outputted from the speaker 104. Further, if it is an image data, the image is shown on the display 102. In this manner as described, the user B can check the message registered by the user A.

(Modification Example)

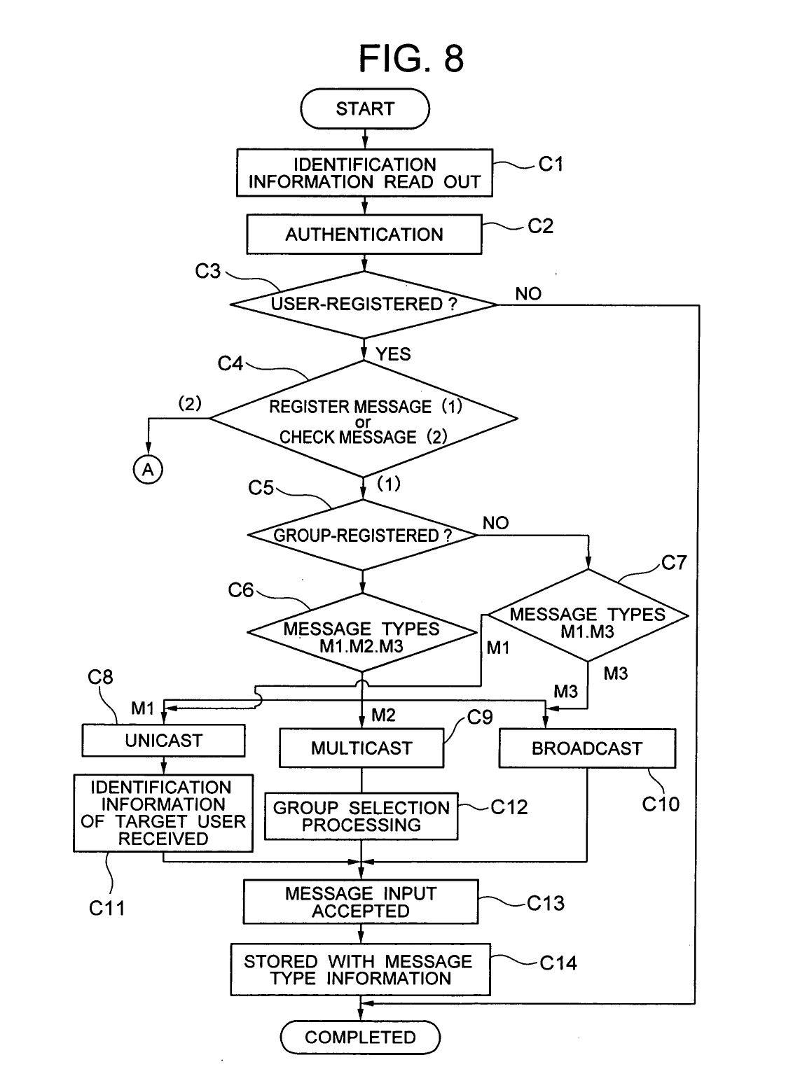

Next, operation of a modification example of the system of the embodiment will be described by referring to FIG. 8 to FIG. 10. In this modification example, a user can selectively register a message to be transmitted to all the registered user (broadcast), to the users within a specific group to which the user oneself belongs (multicast), and to a specific registered (individual) user (unicast), respectively. Therefore, it is also possible to check the messages according to the registered types.

First, when the user presents the card 4, in the same manner as described above, the identification information is read out by the installed terminal 1 and the state of the user registration is checked by the installed terminal 1 and the information storage server 2 (step C1 to step C3). Then, the user is asked whether to register or to check the message (step C4). In the case of registering the message (selects (1) in the step C4), it checks whether or not the identification information is group-registered (step C5).

If it is group-registered, the types of registering the message can be selected from the above-described three types (unicast (M1), multicast (M2), broadcast (M3)). Thus, an indication for encouraging the user to make a selection of the message types is displayed on the display 102 by the user authentication unit 117 and, accordingly, the user selects one of the types from the input panel (step C6). In the meantime, even the user who is not registered in a group (No in step C5) can register the message in the modification example. The user can make a selection from the two types, the unicast (M1) and the broadcast (M3) (step C7).

After receiving the information of the selected message type as described above (steps C8, C9, C10), a message from the user is accepted (step C13). At this time, when the type of the message to be registered is the unicast (M1, step C8), the identification information of the user as the target of outputting the message is received through the input panel 101 from the user registering the message (step C1). The selection of the above-described message types can be made after inputting the message.

The inputted message is stored by the information storage server 2 to the transmission information storing unit 212 along with the message type information (step C14). At this time, the massage may be registered by being related to the identification information and the group information of the user who registered the message.

For example, considering the case of the above-described users A, B, C, first, the user A can register the transmission information by specifying a user as the target for transmitting the information by inputting the identification information of the user as the unicast. Further, by designating the group “α” as the multicast, the transmission information can be registered having the user B belonging to the group as the target. Moreover, as the broadcast, it is possible to register the transmission information having also the user C as the target, who is the registered user but does not belong to any of the groups. In this case, needless to say, the user B is also the target for transmitting the message. On the other hand, the user C can register the transmission information by the broadcast which is directed to all the registered users or the unicast which is directed to a specific user.

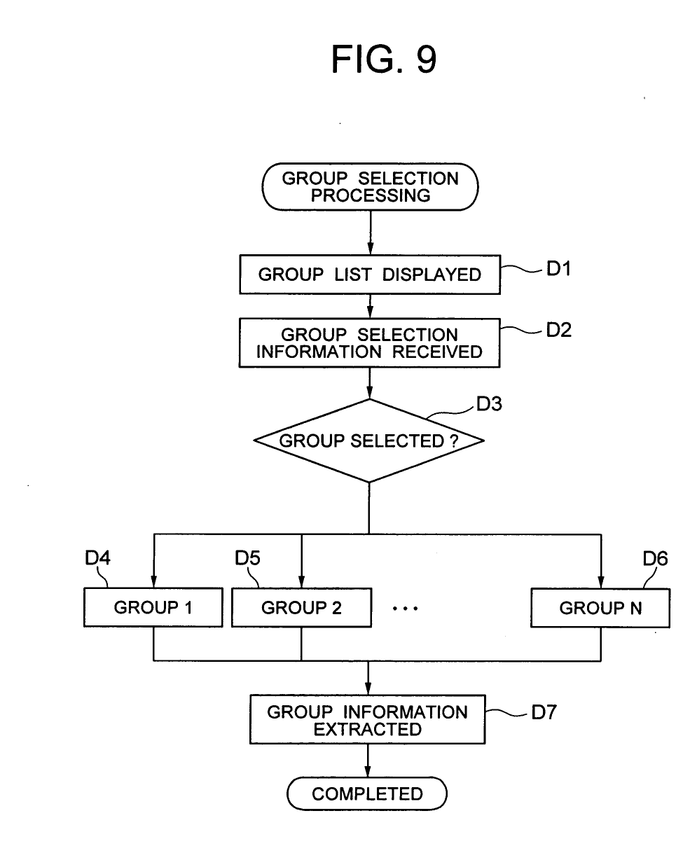

When the user who belongs to a plurality of groups registers the message as the multicast, processing for selecting one of the groups is performed since the target group for transmitting the registered message is unknown. In other words, after selecting the multicast shown in step C9 of FIG. 7, group selecting processing is performed (step C12). The detail of the processing will be described by referring to the flowchart of FIG. 9.

As described above, when the multicast indicating the group as the target is selected as the message type, first, the group list to which the user belongs is displayed (step D1), and the group selection information selected by the user from the list is received by the installed terminal 1 (step D2). At this time, the user selects the group through the input panel 101 and one or a plurality of the groups may be selected (steps D3, D4, D5, D6). Subsequently, the information in regards to the selected group is extracted, e.g., the information specifying the group such as the group name (step D7). The extracted group information is stored in the transmission information storing unit 212 along with the message inputted later by the user by being related thereto.

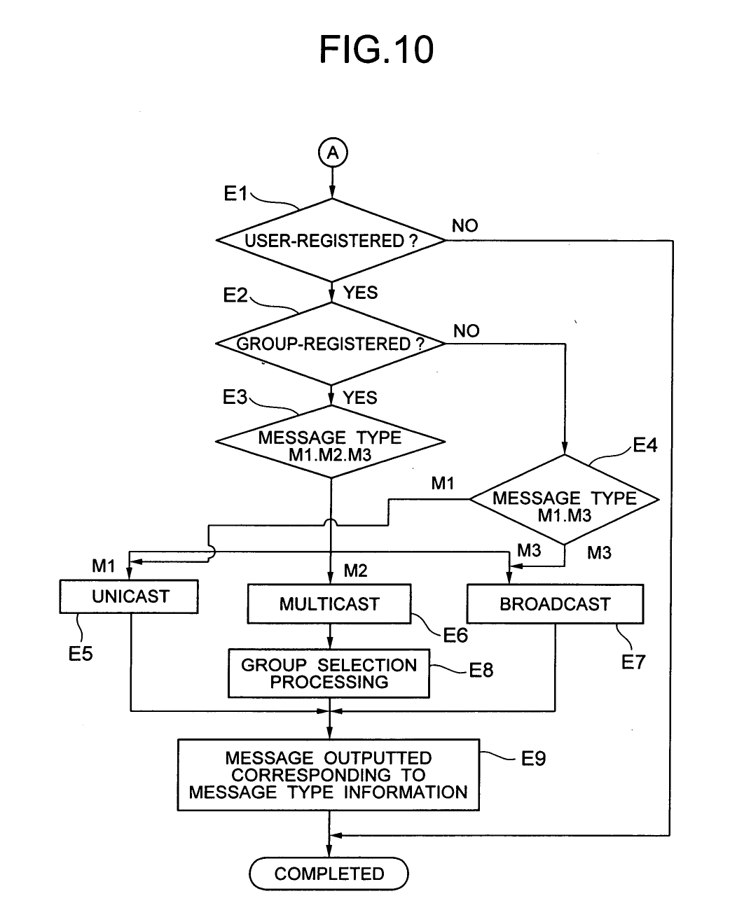

Now, described by referring to FIG. 10 is the operation performed in the case where the user after completing the user authentication selects to check the message in the step C4 of FIG. 8. First, the installed terminal 1 makes an inquiry to the information storage server 2 to check whether or not the message is registered in the transmission information storing unit 212 (step E1). When there is completely no message being registered (NO in step E1), the processing is completed. If there is a message being registered (YES in step E1), it is examined to check whether or not there is a group to which the user belongs based on the identification information of the user (step E2). Then, if the user is registered in a group (YES in step E2), the types of the message to be checked is selected by the user from the unicast (M1), multicast (M2) and the broadcast (M3) (steps E5, E6, E7). When the multicast (step E6) is selected and there are a plurality of groups to which the user belongs, as described above, performed is the processing for making the user select the group whose message is desired to be checked (step E8). If the user is not registered in a group (NO in step E2), the user selects the types of the message desired to be checked from the unicast (M1) and the broadcast (M3).

The message corresponding to the message type being selected as described is read out from the information storage server 2 and outputted to the user through the display, the printer, or the speaker of the installed terminal 1.

Considering the case of the above-described users A, B, C, as for the transmission information registered by the user A as described above, it can be obtained by the user B, when the user A designates the user B as the unicast, when the user A designates the group “α” as the multicast, and when the user A selects the broadcast. The user C can obtain it when the user A designates the user C as the unicast or the user A selects the broadcast.

Thereby, input/output of the information exchanged between the users is performed only in between the users registered in advance. Thus, it enables to suppress the information to be obtained by the other unrelated users who are not registered, so that the security can be improved. In the present invention, especially, the device being easy to be carried, such as the RFID card in which the identification information is stored, is used as a device for inputting the identification information peculiar to the individual to the system, and by presenting it, communication can be achieved easily. Therefore, it can be a convenient communication system with maintained security. Thereby, it becomes unnecessary to always carry the portable telephone or the communicable portable information terminal which is a tool conventionally used for maintaining the security and, inversely, in places where these instruments cannot be carried or in places where it is not necessary to carry them, it becomes possible to achieve communication with other users while maintaining the security. Further, compared to the conventional case where authentication of the individual is performed through inputting information such as a user ID and a password, it is possible to effectively prevent impersonation of others. Thus, it can be referred to as an information transmitting system with higher security.

Further, the user registering the message as the transmission information can designate the target for transmitting the message as other users within the group to which the user oneself belongs or as another specific user. Therefore, it is possible to limit the party with which the user has communication so that the security can be more improved.

Through discriminating the registered users into groups as described above, it enables to charge the fees for using the facilities in the skiing resort by a group unit. Specifically, first, there are POS terminals such as registers having a device for reading out the identification information of the card 4 serving as the lift ticket, which is provided in each facility of the skiing resort such as a restaurant. These are connected to the information storage server 2 through the network N. From the POS terminals, the identification information stored in the presented card 4 and the information on the charged fees used at this time is transmitted to the information storage server 2. Upon receiving it, the information storage server 2 checks whether or not the received identification information is that of a specific user (referred to as a “master user” hereinafter), which is specified in advance in a group, by referring to the registered user information. If determined as being the “master user”, the used fees are charged by being related to the identification information. If not, the identification information of the user who is the “master user” of the group to which the identification information belongs is retrieved for charging the fees by relating it to the identification information of the “master user”. Thus, in advance, the users specify one of the users as the “master user” out of a plurality of the users constituting the group by an input through the installed terminal 1, so that such information is stored as the registered user information. Thereby, all the used fees of the users within the group can be charged by being related to the identification information of the user registered as the “master user”. Then, the “master user” settles the accounts before leaving the skiing resort so that it is unnecessary to carry cash when using the facilities, thereby increasing the convenience for using the facilities. The system can be used in a family as a group, and if there are children in the group, it is unnecessary for the children to carry cash. Thus, it can be utilized to a great extent.

The information transmission system has been described by referring to the case where it is installed in the skiing resorts, however, it is not limited to be installed only in such areas. Although the installing place is not limited, it is more desirable to be used at spots using electronic ticket services. Specifically, it may be installed at amusement parks and hot spring theme parks. Further, it is not limited only to such places but the installed terminal 1 may be installed in business offices, each branches of the same company and, further, in a group companies where the portable telephones are unusable or are hard to be used. When the members of the company use the installed terminal 1, it enables to achieve communication with the superiors and other members while being out.

Further, instead of the RFID card 4 in which the above-described identification information peculiar to the user, other information storing device may be used and the device for reading-out the identification information may have a configuration suitable for this. For example, information stored in an information storing device may be read out by an optical reader, or a communication device between the device and the reading-out apparatus may be achieved using infrared light or Blutooth. Further, the above-described information storing device is not limited to the ones for storing electronic information but may be ones for recording the information by printing it on a paper medium. For example, it may be a paper medium in which barcodes indicating the identification information by each user are recorded, and the reading-out apparatus may be formed with a barcode reader.

### Second Embodiment

Next, a second embodiment of the present invention will be described. Although the embodiment has almost the same configuration as the above-described system of the first embodiment, it is different in respect that the positional information of the user can be obtained from the installed terminal 1. It will be described in detail hereinafter.

First, in the embodiment, further provided are a plurality of identification information reading-out apparatus (not shown) being connected to the information storage server 2 through a network N. The identification information reading-out apparatus is an apparatus separately provided from the above-described installed terminal 1. For example, it may be the gate of the lift in the skiing resort. In the gate as the identification information reading-out apparatus, formed is an identification information reading-out unit for reading out the identification information stored in the above-described information storing device 4 which also serves as a lift ticket carried by a user through a short-range radio communication as described above. When the user brings the card which is the above-described information storing device 4 serving as the lift ticket near the reading-out unit, the identification information can be inputted. Further, the gate is constituted of a computer comprising a CPU and a memory, which stores the identification information of the users who can use the lift at present and compares it with the inputted identification information. When the information coincides, the gate is opened for enabling the user to use the lift. However, the authentication processing for using the lift is not limited to the above-described processing. Further, the above-described authentication processing may be executed through another computer being connected to the gate through the network.

The CPU of the gate has a function of obtaining the time information at the time of reading out the identification information from the card 4 from the CPU itself. Further, in the memory of the gate, stored in advance is the installed area information indicating the installed area of the gate, and there is a function being provided thereto for transmitting, by relating, the installed area information, the above-described time information and, further, the read out user identification information to the information storage server through the network (a time information transmitting device).

In accordance with this, the installed terminal 1 has a function of receiving the authentication time request information for requesting the information indicating the authentication time of other user, which is inputted from another user being authenticated as the registered user based on the authentication result transmitted from the user authentication device of the information storage server 2 and of transmitting the authentication time request information to the information storage server 2 (an authentication time request transmitting device). Specifically, when the user brings the device near the installed terminal 1 for inputting the identification information, a menu list is shown on the display 102 of the installed terminal 1. In the list, a menu for requesting the information indicating the authentication time state of other user is listed to be selected. When it is selected through the input panel 101, the information indicating the request for authentication time is transmitted to the information storage server 2.

Further, the information storage server 2 according to the embodiment has a function of storing, by relating, the time information, the installed area information, and the identification information transmitted from the gate (time information storing device). Also, it has a function of transmitting the user information indicating the user along with the stored authentication time information and the installed area information of the installed terminal to the installed terminal 1 for providing it to the user requesting the authentication time information, according to the above-described authentication time request information transmitted from the installed terminal 1 (an authentication time output device). The user information may be the user identification information itself in which the time of being authenticated at the gate is recorded. However, in the embodiment, it is the name of the user stored in the registered user storing unit 211 in the information storage server 2 at the time of user registration. The user information is extracted from the registration user storing unit 211 according to the user identification information stored along with the authentication time information.

Upon receiving it, the installed terminal 1 provides the user with the authentication time information (authentication time information supplying device) through showing the information which indicates the time and the place where the user was authenticated in the past on the display 102, etc. At this time, if the user requesting the authentication time information belongs to a prescribed group, the time information, and the like of all the users belonging to the group is outputted on the display.

Thereby, it is possible to precisely grasp the moving state of other users even in an area where the portable terminal cannot be used. Thus, even if the transmission information cannot be transmitted, it is possible to increase a chance of meeting other users by ambushing for them. Especially, by recording the time of passing the gate where the users necessarily pass through in the skiing resort, the behavior of other users can be more precisely grasped.

At this time, the time when each user is authenticated by the installed terminal 1 may also be recorded and provided to the user requesting the authentication time. Thereby, it is also possible to easily grasp the behavior of the users who are at rest in a restaurant or the like without using the lift.

### Third Embodiment

Next, a third embodiment of the present invention will be described. In the embodiment, a device for authenticating the user is a person-authenticating technology using biometrics. That is, the above-described installed terminal 1 does not read out the identification information peculiar to the user from the information storing device such as the FRID card 4 as described above, but it comprises an apparatus for reading out identification information indicated on a human body, which is different by each user, from a specific body part of the user oneself.

For example, the identification information reading-out device comprising the above-described radio communication unit 1D is constituted by an optical scanner which reads out finger prints. By placing the finger tip of the user on the optical scanner, the finger print on the finger tip is read out and the read-out finger print information peculiar to the user is transmitted to the identification information reading-out unit 112. The finger print information is user-registered in the same manner as described above for performing user authentication. Other processing such as registration and output of the transmission information is the same as the ones described above. However, in the case where the user registering the transmission information specifies the target user to whom it is outputted (in the case where the above-described message type is the unicast), the output target user may be specified by using the identification information through registering the identification information peculiar to the user in advance along with the finger print information at the time of user registration, since it is difficult for the registering user to know the finger print information of others.

As described above, by using the physical characteristic of the user such as the finger print, it is unnecessary to always carry the portable telephone or the communicable portable information terminal but also unnecessary to carry the above-described information storing device in which the identification information is stored. Therefore, the convenience can be more improved. Further, it does not use passwords and the like so that it enables to effectively prevent impersonation by others.

Like the finger prints, as the physical characteristics for effectively authenticating individuals, there are the retina (patterns of capillaries in the eye ground), iris (patterns of folds in the muscle for opening/closing the pupil), complexion, vein, voiceprint, and the like. Accordingly, it may be in the configuration in which the installed terminal 1 comprises an apparatus for reading out these as the identification information reading-out device. Then, the read-out information may be user-registered for performing the user authentication.

The information transmission system as the present invention can be industrially applied as a system which can achieve communication with other users, while maintaining the security in the areas where the communication device such as the portable telephone cannot be used.

1. An information transmission system, comprising:
a registered user storing device for storing identification information peculiar to an individual user being inputted from outside as a registered user information;
a transmission information receiving device for receiving and storing transmission information which is inputted by a user to be transmitted to another user;
an identification information reading-out device for reading out identification information peculiar to an individual user;
an output request receiving device for receiving transmission information output request information which is inputted by a user along with the read-out identification information; and
a transmission information supplying device for outputting the stored transmission information to a user, when the identification information received along with the transmission information output request information is registered in the registered user information.

2. The information transmission system according to claim 1, wherein the identification information reading-out device reads out identification information peculiar to an individual user from an information storing device carried by the user.

3. The information transmission system according to claim 1, wherein the identification information reading-out device reads out, from a specific body part of a user, identification information peculiar to each user being indicated on the body part.

4. The information transmission system according to claim 1, further comprising a user authentication device for authenticating whether or not identification information read out by the identification information reading-out device is stored in the registered user information, wherein:
the transmission information receiving device receives and stores transmission information which is inputted to be transmitted to another user from a user being authenticated as a registered user by the user authentication device; and
the output request receiving device receives transmission information output request information which is inputted from another user being authenticated as a registered user by the user authentication device.

5. The information transmission system according to claim 4, further comprising:
a time information storing device for storing time information at which identification information is read out along with the identification information, when the identification information read out by the identification information reading-out device is authenticated by the user authentication device as that of a registered user;
an authentication time request receiving device for receiving authentication time request information for requesting information which indicates authentication time state of other user, which is inputted by the another user being authenticated as a registered user by the user authentication device; and
an authentication time output device for extracting user information, specifying the user and recognizable by the another user, which is stored in advance in the registered user information by the registered user storing device along with the stored user authentication time information based on the user identification information stored along with the authentication time information, and outputting it to the another user according to the received authentication time request information

6. The information transmission system according to claim 1, wherein:
the registered user storing device has a group registration function for discriminating identification information of each user into specific groups according to input from outside and storing them as the registered user information, and has a group specifying function for specifying a group to which the identification information read out by the identification information reading-out device according to the registered user information belongs;
the transmission information storing device has a function of storing the transmission information, which is inputted from a user having identification information belonging to a specific group, by relating it to the specific group; and
the transmission information supplying device has a function of outputting the transmission information which is stored by being related to the group to another user according to the transmission information output request information inputted from a user having identification information belonging to a specific group.

7. The information transmission system according to claim 4, further comprising:
a time information storing device for storing time information at which identification information is read out along with the identification information, when the identification information read out by the identification information reading-out device is authenticated by the user authentication device as that of a registered user;
an authentication time request receiving device for receiving authentication time request information for requesting information which indicates authentication time state of other user, which is inputted by the another user being authenticated as a registered user by the user authentication device; and
an authentication time output device for extracting user information of other user for specifying the user and recognizable by the another user, which is stored in advance in the registered user information by the registered user storing device, along with the stored authentication time information of the other user belonging to a specific group to which the another user who has inputted the authentication time request information belongs, based on the identification information of the other user stored along the authentication time information, and for outputting it to the another user according to the authentication time request information inputted by another user having identification information belonging to a specific group based on an authentication result obtained by the user authentication device.

8. The information transmission system according to claim 1, wherein
the transmission information receiving device has a function of receiving inputted identification information for specifying other user as a target for outputting the transmission information from a user who inputs the transmission information along with the transmission information and a function of outputting the transmission information relating to the identification information to the another user; and
the transmission information supplying device has a function of outputting the transmission information related to the identification information to the another user when the identification information of the user who has inputted the output request information coincides with the specific identification information which is being related at the time of storing the transmission information.

9. The information transmission system according to claim 1, further comprising a plurality of installed terminals and an information storage server connected through a network, wherein:
the installed terminal comprises, in addition to the identification information reading-our device, the output request receiving device and the transmission information supplying device, a user authentication inquiry device which inquires whether or not a user is a pre-registered user by transmitting the read-out identification information to the information storage server and also receives an authentication result from the information storage server;
the transmission information receiving device receives transmission information for another user, which is inputted by the user being authenticated as a registered user based on an authentication result and transmits the transmission information to the information storage server;
the output request transmitting device receives transmission information output request information for another user, which is inputted by a user being authenticated as a registered user based on an authentication result and transmits the transmission information output request information to the information storage server;
the transmission information supplying device outputs to another user the transmission information outputted from the information storage server according to the transmission information output request information; and
the information storage server comprises: in addition to the registered user storing device and the transmission information receiving device, a user authentication device for authenticating whether or not the identification information transmitted from the installed terminals is user-registered based on the registered user information and for informing an authentication result to the installed terminals; a transmission information storing device for receiving and storing transmission information inputted by the registered user, which is transmitted from the installed terminals; and a transmission information output device for outputting to the installed terminals the stored transmission information for providing it to the registered user according to the transmission information output request information inputted by the registered user, which is transmitted from the installed terminals.

10. The information transmission system according to claim 9, wherein
the installed terminal further comprises: a time information transmitting device for transmitting, to the information storage server, by relating, time information at which identification information of a user being authenticated as a registered user based on an authentication result obtained from the user authenticating device of the information storage server is read out by the identification information reading-out device, installing area information of the installed terminals, which is stored in advance in the installed terminals, and identification information of the user by relating them; an authentication time request transmitting device which receives authentication time request information for requesting information indicating an authentication time state of other users, which is inputted from another user being authenticated as a registered user based on an authentication result from the user authenticating device of the information storage server and transmits the authentication time request information to the information storage server; and an authentication time information supplying device for outputting to the user the information which is outputted from the information storage server according to the authentication time request information, and
the information storage server comprises: a time information storing device for storing the time information transmitted by the time information transmitting device of the installed terminals, the installed area information, and the identification information by relating them; and an authentication time output device for extracting the user information for specifying the user and recognizable by another user, which is stored in advance in the registered user information by the registered user storing device based on the user identification information stored along the authentication time information and for outputting it to the installed terminal so as to supply it to the another user along with the stored authentication time information and the installed area information of the installed terminals according to the authentication time request information inputted by the registered user, which is transmitted from the installed terminals.

11. The information transmission system according to claim 9, wherein
the information storage server comprises a plurality of identification information reading-out apparatus connected through the network;
the identification information reading-out apparatus comprises: an identification information reading-out device for reading out the identification information from an information storing device in which identification information provided by a user, which is peculiar to the user, is stored; and a time information transmitting device which transmits to the information storage server time information at which the identification information is read out by the identification information reading-out device, installed area information of the apparatus stored in advance in the identification information reading-out device, and identification information of the user by relating them;
the installed terminals comprises: an authentication time request transmitting device which receives authentication time request information for requesting information indicating an authentication time state of other user, which is inputted from another user being authenticated as a registered user based on the authentication result obtained from the user authentication device of the information storage server, and transmits the authentication time request information to the information storage server; and an authentication time information supplying device for outputting to the user the information outputted from the information storage server according to the authentication time request information; and
the information storage server comprises: a time information storing device for storing the time information, the installed area information, and the identification information transmitted from the identification information reading-out device by relating them; and an authentication time output device for extracting the user information for specifying the user and recognizable by another user, which is stored in advance in the registered user information by the registered user storing device based on the user identification information stored along the authentication time information and for outputting it to the installed terminal so as to supply it to the another user along with the stored authentication time information and the installed area information of the installed terminals according to the authentication time request information inputted by the registered user, which is transmitted from the installed terminals.

12. An information storage server being connected to installed terminals through a network for supervising transmission of transmission information from a user to another user, which is inputted from the installed terminals, wherein
the information storage server comprises:
a registered user storing device for storing identification information peculiar to an individual user as registered user information according to input from outside;
a user authentication device which authenticates whether or not the user identification information read out by an identification information reading-out device provided to the installed terminals is user-registered based on the registered user information, and also informs an authentication result to the installed terminals;
a transmission information storing device for receiving and storing transmission information for another user from the installed terminals, which is inputted by a user being authenticated as a registered user based on the authentication result; and
a transmission information output device which, upon receiving, from the installed terminal, transmission information output request information inputted to the installed terminal by another user who is authenticated as a registered user by the authentication result, outputs the stored transmission information to the installed terminal through the network for providing it to the registered user through the installed terminal according to the transmission information output request information.

13. The information transmission system according to claim 12, wherein the user identification information is identification information peculiar to a user, which is read out from an information storing device carried by a user.

14. The information transmission system according to claim 12, wherein the user identification information is identification information peculiar to each user being read out from a specific body part of a user, which is indicated on the body part.

15. An information transmission method comprising:
an identification information reading-out step in which an identification information reading-out device reads out identification information from an information storing device in which the identification information provided by a user being peculiar to the user is stored;
a user authentication step in which a user authentication device authenticates whether or not the identification information read out in the identification information reading-out step is stored in the registered user storing device in which identification information inputted from outside is stored in advance as registered user information; and
a transmission information receiving step in which transmission information receiving device receives transmission information inputted from a user who is authenticated as a registered user based on an authentication result obtained in the user authentication step and stores it to the transmission information storing device, and in addition, the method comprising: at least after completing the transmission information receiving step once,
an output request receiving step in which an output request device, when the identification information of another user read out in the identification information reading-out step is authenticated as that of a registered user based on an authentication result obtained by the user authentication step, receives transmission information output request information inputted by the user, subsequently to the identification information reading-out step and the user authentication step; and
a transmission information supplying step in which a transmission information supplying device outputs to the user the transmission information stored in the transmission information storing device according to the transmission information output request information received in the output request receiving step.

16. An information transmission method, comprising:
an identification information reading-out step in which an identification information reading-out device reads out identification information peculiar to an individual user, which is indicated on a body of the user, from a specific body part of the user oneself;
a user authentication step in which a user authentication device authenticates whether or not the identification information read out in the identification information reading-out step is stored in the registered user storing device in which identification information inputted from outside is stored in advance as registered user information; and
a transmission information receiving step in which transmission information receiving device receives transmission information inputted from a user who is authenticated as a registered user based on an authentication result obtained in the user authentication step and stores it to the transmission information storing device, and in addition, the method comprising: at least after completing the transmission information receiving step once,
an output request receiving step in which an output request device, when the identification information of another user read out in the identification information reading-out step is authenticated as that of a registered user based on an authentication result obtained by the user authentication step, receives transmission information output request information inputted by the user, subsequently to the identification information reading-out step and the user authentication step; and
a transmission information supplying step in which a transmission information supplying device outputs to the user the transmission information stored in the transmission information storing device according to the transmission information output request information received in the output request receiving step.
